(19) United States
(12) Patent Application Publication
(10) Pub. No.: US 2006/0147743 A1
(43) Pub. Date: Jul. 6, 2006

(54) Metallic sandwich sheet

(76) Inventors: Olivier Bouaziz, Metz (FR); Pascal Drilliet, Rozerieulles (FR); Jean-Claude Sartini, Hussigny-Godbrange (FR)

Correspondence Address: SUGHRUE MION, PLLC, 2100 PENNSYLVANIA AVENUE, N.W., SUITE 800, WASHINGTON, DC, 20037, US

(21) Appl. No.: 10/535,177

(22) PCT Filed: Nov. 14, 2003
(86) PCT No.: PCT/FR03/03376

§ 371 Date: Dec. 20, 2005

(30) Foreign Application Priority Data
Nov. 28, 2002 (FR) 02/14932

(51) Int. Cl. B21C 37/00; B32B 5/18; B23K 13/01

(52) U.S. Cl. 428/608; 428/613; 219/617

(57) ABSTRACT

The invention concerns a sandwich-type metal sheet (2), adapted to a forming and welding operation, and exhibiting excellent resistance at high temperatures, comprising two metal sheet facings (1, 1′) having a melting point Tp, and a metallic core (4) having a melting point Ta, Ta capable of being equal to or different from Tp, whereby the core (4) has a density lower than the density of each of the facings (1, 1′), and the core (4) and each of the facings (1, 1′) are mutually bound by means of a metallic binding agent (3, 3′) having a melting point Tm lower than Ta and Tp. The invention also concerns a method for making said sandwich-type metal sheet (2), and its use in the automotive industry.

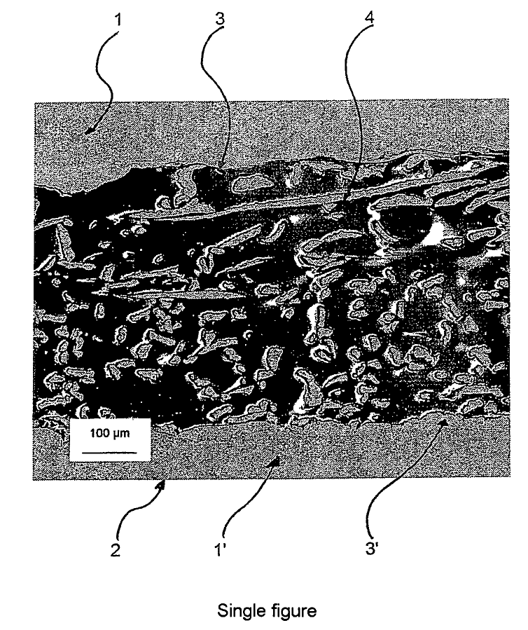

### BACKGROUND OF THE INVENTION

The present invention relates to a sandwich sheet suitable for a forming and welding operation and exhibiting excellent resistance to high temperatures, comprising two sheet metal facings and a metal core, to its manufacturing process and to its use for producing parts for motor vehicles.

In general, the main advantage of sandwich sheets over conventional metal sheets lies in the weight saving that can be achieved in the production of parts having predetermined mechanical strength specifications; this advantage is very important in automobile applications, especially for reducing the fuel consumption of the vehicle.

Sandwich sheets used for the manufacture of parts for motor vehicles must meet not only welding and forming requirements, for example those performed by drawing, bending and crimping, but also temperature withstand requirements. This is because during the operation of painting the sheet, which may include a prior anticorrosion treatment, the sheet is subjected to high temperatures and durations, generally between 140 and 220° C. for 20 to 30 minutes, that are sufficient to allow baking and/or crosslinking of the various coating layers applied.

### DESCRIPTION OF THE PRIOR ART

For this purpose, sandwich sheets are known that comprise two sheet metal facings joined together by a core formed by a polymer-based layer that includes a continuous textile web of thermoplastic polymer fibers, impregnated with a thermoset polymer material for impregnating the web and for adhesion to the facings. These sheets exhibit good formability and good temperature withstand.

However, they have drawbacks, such as variations in the thickness of the sandwich sheet and defects in the adhesion of the textile web to the sheet metal facings, since the web is not uniform. However, above all, this type of sandwich sheet including a polymer are not weldable, or not easily weldable, with in addition the release of toxic fumes, which makes them incompatible with use for the manufacture of parts for motor vehicles.

Apart from these drawbacks, the process for manufacturing such composite sandwich sheets does not allow acceptable productivity levels to be achieved, since the step of making the preimpregnated web adhere to the sheet metal facings is a very slow step.

Also known, from patent FR 2 767 088, are sandwich sheets composed of two steel facings linked together by a core made of a steel wool. The steel wool is joined to the steel facings by capacitor-discharge arc welding. Admittedly such all-steel sandwich sheets are perfectly weldable and withstand temperatures well above 160° C. However, the process for manufacturing such sheets cannot be carried out on an industrial scale as, to weld the steel wool to the steel facing it is necessary to weld the whole assembly at a temperature above 1300° C. Furthermore, at this temperature level the structure of the steel changes, which is undesirable if it is intended to preserve the mechanical properties and the formability of the steel facings and of the steel wool.

### SUMMARY OF THE INVENTION

The object of the present invention is therefore to remedy these drawbacks and to propose formable and weldable sandwich sheets exhibiting good resistance to high temperatures and a good surface appearance, the manufacturing process for which is easy to implement.

For this purpose, the subject of the invention is a sandwich sheet suitable for a forming and welding operation and exhibiting excellent resistance to high temperatures, comprising two sheet metal facings having a melting point T_{f}; and a metal core having a melting point T_{c}, it being possible for T_{c} to be equal to or different from T_{f}, characterized in that the core has a density less than the density of each of the facings and in that the core and each of the facings are bonded together by means of a metal bonding agent having a melting point Tₘ of less than T_{c} and less than T_{f}.

The sandwich sheet according to the invention may also have the following features:

the metal core occupies between 10 and 80% of the volume that separates the two sheet metal facings;

the metal core occupies between 20 and 60% of the volume that separates the two sheet metal facings;

the core consists of a metal wool, a knitted metal fabric, a woven metal fabric, a metal foam or a metal sponge;

the core is made of steel;

the sheet metal facings are made of steel; and

the sheet metal facings and the metal core are made of steel, and the metal bonding agent is chosen from tin and its alloys, zinc and its alloys, and aluminum and its alloys.

The subject of the invention is also a process for manufacturing a sandwich sheet, suitable for a forming and welding operation, and exhibiting excellent resistance to high temperatures, comprising two sheet metal facings having an internal face and an external face, and having a melting point T_{f}, these being bonded together by a metal core having a melting point T_{c}, it being possible for T_{c} to be equal to or different from T_{f}, the internal face of each of the two facings being located so as to face the core, according to which it comprises the steps consisting in:

inserting the metal core between the two sheet metal facings precoated on their internal face with a metal coating, the melting point T_{coat} of which is below the melting point T_{f} of the sheet metal facing and below the melting point T_{c} of the metal core;

heating the assembly formed by the two sheet metal facings between which the metal core has been inserted at a temperature T lying between the melting point of the metal coating T_{coat} minus 50° C. and the melting point of the metal coating T_{coat} plus 200° C., under speed and duration conditions such that the core adheres to each of the facings; and

cooling the assembly.

The process for manufacturing a sandwich sheet according to the invention may also have the following features:

between the heating and cooling steps, pressure is applied to the assembly formed by the sheet metal facings and the metal core, said pressure being adjusted so as not to damage the structure of the metal core;

the assembly formed by the sheet metal facings and the metal core is heated by induction;

the thickness of the metal coating of each of the sheet metal facings is between 5 and 350 μm;

the thickness of the metal coating of each of the sheet metal facings is between 20 and 80 μm;

the rate at which the assembly formed by the sheet metal facings and the metal core is heated is greater than or equal to 30° C./s;

the time during which the assembly formed by the sheet metal facings and the metal core is heated is less than 15 s;

the melting point of the coating T_{coat} is less than 0.9 times the melting point of the sheet metal facing T_{f} and less than 0.9 times the melting point of the metal core T_{c};

the internal face of each of the sheet metal facings is coated by hot dipping in a bath of liquid metal chosen from tin and its alloys, zinc and its alloys and aluminum and its alloys;

the sheet metal facings are made of steel;

the density of the metal core is less than the density of each of the sheet metal facings;

the core consists of a metal wool, a knitted metal fabric, a woven metal fabric, a metal foam or a metal sponge; and

the external face of at least one of the two sheet metal facings (1, 1′) is coated with a coating, the melting point Tₑ of which is above the melting point of the metal coating that coats the internal face of each of the two facings (1, 1′) T_{coat} plus 200° C.

The subject of the invention is also the use of the above sandwich sheet for the production of automobile body parts that are formed, painted and then heat treated.

The subject of the invention is also the heat treatment of these parts at above 160° C.

The features and advantages of the present invention will become more clearly more apparent in the course of the following description, given by way of non-limiting example, with reference to the single appended FIGURE in which a sectional view of a sheet according to the invention is shown.

### DESCRIPTION OF THE DRAWING

The invention consists in using the metal layer coating the internal face of the sheet metal facing, the internal face of the facing being located facing the core, as a brazing element in order to ensure adhesion between the sheet metal facing and the metal core.

As shown in the single FIGURE, each facing 1, 1′ of the sandwich sheet 2 according to the invention consists of a metal sheet having a melting point T_{f} and a thickness of between, for example, 0.1 mm and 2 mm, preferably between 0.2 mm and 0.5 mm. Preferably, steel sheets are chosen that have better mechanical properties than aluminum sheets and can be drawn more easily. The type of steel will be chosen according to the application to which the sandwich sheet 2 is intended. Thus, for example, a carbon steel will be chosen to manufacture a hood or a door, while a stainless steel will be chosen to manufacture an exhaust line pipe.

The metal core 4 of the sandwich sheet 2 according to the invention has a melting point T_{c} equal to or different from the melting point T_{f} of each of the facings 1, 1′, and a density less than that of the facings 1, 1′ so as to lighten the sheet 2.

### DESCRIPTION OF THE PREFERRED EMBODIMENTS

In a preferred embodiment, the core 4 consists of a metal wool, a knitted metal fabric, a woven metal fabric, a metal foam or a metal sponge.

In another preferred embodiment, the core occupies between 10 and 80%, preferably between 20 and 60%, of the volume that separates the two sheet metal facings 1, 1′ and has a thickness of between 0.5 and 2 mm.

Above 80% occupation of the inter-facing volume, the weight saving of the resulting sandwich sheet 2 is insufficient.

Below 10% occupation of the inter-facing volume, the core 4 becomes fragile and risks being crushed during forming of the sandwich sheet 2.

Between 20 and 60% occupation of the inter-facing volume, the core 4 offers a good compromise between weight saving and strength.

The material of the metal core 4 is preferably steel, either a carbon steel or a stainless steel, as this material exhibits better formability than, for example, aluminum.

The steel wool is obtained by shaving, preferably in the work-hardened state, in order to increase the mechanical properties of the structure. The strands of steel wool have a mean length of 70 cm and their diameter may vary from 50 to 500 μm. Preferably, the diameter of the steel wool strands is about 200 μm. This diameter must be uniform in order to avoid any weakening, which would result in breakages.

The knitted steel fabric is formed from several steel threads with a diameter of between 10 and 50 μm, knitted together.

The woven steel fabric is also formed from one or more steel threads having a diameter of between 10 and 50 μm, woven together.

The adhesion between the core 4 and each of the facings 1, 1′ is provided by a metal bonding agent 3, 3′ having a melting point Tₘ below the melting point of each of the facings T_{f} and below the melting point of the core T_{c}.

When the core 4 and the two sheet metal facings 1, 1′ are made of steel, the metal bonding agent 3, 3′ is chosen from tin and its alloys, zinc and its alloys, and aluminum and its alloys.

The metal bonding agent may be in the form either of a discontinuous layer or, preferably, a continuous layer so as to ensure the best possible adhesion between the core and the two facings.

Thus, prior to the manufacture of the sandwich sheet, the internal face of each of the two sheet metal facings is coated with a metal coating having a melting point T_{coat} below the melting point of the sheet metal facing T_{f} and below the melting point of the metal core T_{c}, so that the coating, on melting, brazes the metal core. This is because it is essential, in order to assemble the sheet metal facings with the metal core by brazing, for the melting point of the metal coating T_{coat}, which acts here as a filler metal, to be below the melting point of the facings T_{f} and below the melting point of the core T_{c}, so that the material of the coating melts well before the material of the core and the material of the sheet metal facings.

Preferably, so as to avoid any risk of the sheet metal facing 1, 1′ and the metal core 4 melting in the event of excessive or overly long heating, the internal face of each of the two sheet metal facings 1, 1′ is coated with a metal coating whose melting point T_{coat} is preferably less than 0.9 times the melting point of the sheet metal T_{f} and less than 0.9 times the melting point of the metal core T_{c}.

As an example, to form a sandwich sheet comprising two steel sheet metal facings with a steel core, the facings are coated on at least one of their faces with a metal coating chosen from the following materials:

tin: melting point 230° C.;

zinc: melting point 420° C.;

zinc alloys, such as for example zinc-aluminum alloy containing about 5% aluminum by weight, the melting point of which is 381° C.; and

aluminum and its alloys, such as for example the aluminum-iron alloy containing 2 to 4% iron by weight, the melting point of which is about 660° C., or else aluminum-silicon alloys containing 5 to 11% iron by weight and 2 to 4% iron by weight, the melting point of which is about 680° C.

A metal coating with a thickness of between 5 and 350 μm is deposited, on the internal face of each of the two sheet metal facings 1, 1′ that is intended to face the core, either by electroplating or by vacuum deposition or, preferably, by hot dipping in a liquid bath of the coating material in the molten state.

If the thickness of the metal coating is less than 5 μm, there is insufficient impregnation of the core 4 by the coating during brazing and consequently the adhesion between the sheet metal facing 1, 1′ and the core 4 is insufficient, with the risk of the sandwich sheet 2 delaminating.

On the other hand, coating the internal face of the facing with a coating of greater than 350 μm in thickness represents an additional cost, and this also does not improve the adhesion between the core 4 and the facings 1, 1′.

Preferably, the thickness of the metal coating is between 20 and 80 μm as, at this thickness level, the adhesion between the facings 1, 1′ and the core 4 is sufficient for the sandwich sheet 2 not to delaminate, even after a severe forming operation, such as for example bending.

To manufacture the sandwich sheet 2, the procedure is as follows:

the metal core 4 is inserted between two sheet metal facings 1, 1′, the internal face of which has been precoated, in such a way that the coated internal face of the facings 1, 1′ faces the core 4;

the whole assembly, formed by the two sheet metal facings 1, 1′ between which the metal core 4 has been inserted, is heated to a temperature T of between the melting point of the metal coating T_{coat} minus 50° C. and the melting point of the metal coating T_{coat} plus 200° C., preferably at a heating rate of not less than 30° C./s and preferably for a time of less than 15 s, so as to melt the material of the metal coating; and

the assembly is cooled.

Upon softening or melting, the material of the metal coating brazes the facing 1, 1′ onto the metal core 4 by impregnation of the surface of the metal core 4, thereby ensuring mechanical adhesion to the facings 1, 1′/core 4 assembly. The softened or molten metallic material impregnates the metal strands making up the wool, the woven fabric or the knitted fabric of the core 4 that are located on the surface. If the assembly formed by the two facings 1, 1′ and the core 4 is heated to a temperature T below the melting point of the metal coating T_{coat} minus 50° C., the material of the coating does not soften sufficiently and does not impregnate the material of the core 4. At this temperature level, brazing between the facing 1, 1′ and the core 4 is impossible and the sandwich sheet 2 cannot be formed.

If the assembly is heated to a temperature T above the melting point of the metal coating T_{coat} plus 200° C., the material of the coating then runs the risk of boiling. Some of the coating material will escape from the sandwich sheet 2, forming drops on the free edges of the facings. This makes the coating non-uniform and consequently prevents good fastening of the facing 1, 1′ to the core 4.

Heating the assembly to a temperature T between the melting point of the coating plus 50° C. and the melting point of the material plus 100° C. ensures good melting of the metal coating material and very good adhesion of the core 4 to the facings 1, 1′ is obtained, without any risk of subsequent delamination and without any risk of the coating material escaping.

If the heating rate is less than 30° C./s, it is necessary to maintain the heating temperature T_{coat} for a time of greater than 15 s in order to completely soften or melt the coating material, such a time penalizing the productivity.

When the heating time is greater than 15 s, the metal core composed of wool, woven fabric, knitted fabric, foam or sponge starts to absorb some of the coating material, which causes the adhesion between the core 4 and the facings 1, 1′ to deteriorate.

Preferably, the heating time is less than 3 s.

To heat the assembly formed by the facings 1, 1′ and the core 4, and consequently to soften or melt the metal coating that coats the facings 1, 1′, at least one heating element, such as for example an inductor, is placed on either side of the assembly, and over its entire width.

According to another embodiment, the assembly formed by the facings 1, 1′ and the core 4 is heated by calendering it between two heated rolls.

To improve the adhesion between the facings 1, 1′ and the core 4, pressure is applied to the sandwich sheet 2, the pressure being adjusted so as not to damage the structure of the core 4 and not to deform the facings 1, 1′. The pressure applied to the sandwich sheet 2 must be sufficiently low so that, for example, the metal wool or the knitted metal fabric is not crushed and so that it thus maintains the integrity of its mechanical properties.

This pressure may be applied by the calendering rolls, by spraying a fluid on either side of the facings, 1, 1′/core 4 assembly or else by making the facings 1, 1′/core 4 assembly run over a magnetized roll.

The embodiments of the sandwich sheet 2 according to the invention that have just been described are not limiting.

Thus, prior to the manufacture of the sandwich sheet, it is also possible to coat the external face of at least one of the two sheet metal facings 1, 1′ with a coating whose melting point Tₑ is above the melting point of the metal coating that coats the internal face of each of the two facings 1, 1′ T_{coat} plus 200° C. If it is desired to employ facings 1, 1′ coated on their external face, it is necessary to ensure that the coating used does not melt when the assembly formed by the two facings between which the metal core 4 has been inserted is heated.

Typically, in this case the internal face of the facings 1, 1′ will be coated with a zinc layer and the external face of the facings 1, 1′ will be coated with an aluminum-iron or aluminum-silicon layer.

However, usually the sheet metal facing 1, 1′ will be coated only on its internal face before the sandwich sheet 2 has been manufactured, and the coating of the external face of the facings 1, 1′ will be carried out, for example in an electroplating bath, only when the sandwich sheet 2 has been manufactured.

The forming of the sandwich sheet 2 according to the invention is preferably carried out by drawing, bending or profiling. When the core 4 consists of a metal exhibiting good ductility, such as for example steel, the sandwich sheet 2 according to the invention withstands severe drawing and/or bending and/or profiling conditions. This allows the sandwich sheet 2 according to the invention to be used to produce formed automobile body parts such as, for example, hoods, doors or exhaust line pipes.

These parts are then, especially in the case of visible parts, painted and then heat treated.

Prior to the painting operation, the sandwich sheet 2 may undergo an anticorrosion pretreatment of the cataphoretic type. The application of the paint can then be carried out by depositing powder (electrostatic, fluidized bed, etc.), or by the spraying or coating of a liquid paint in solution or of a molten polymer layer. Finally, the sandwich sheet 2 is treated at temperatures above 160° C., preferably above 180° C., temperatures that are generally reached during the steps of curing of the anticorrosion pretreatments or of baking of the paint itself.

The sandwich sheets 2 obtained according to this process have, compared with sandwich sheets formed from a metal wool welded between two metal facings, the following advantages:

a less energy-consumptive manufacturing process;

no modification of the structure of the sheet metal facings 1, 1′ and of the metal core 4. This is because, in a preferred embodiment of the sandwich sheet 2 according to the invention, in which the sheet metal facings 1, 1′ are made of steel, the brazing of the steel facing to the metal core 4 is never carried out at a temperature above 700° C. Now, at this temperature level the microstructure of the steel is not modified and it retains all its properties. For example, a dual-phase steel will preserve its structure. According to the prior art, welding at a temperature of 1300° C. will melt the steel facing (and the metal core, if this is for example made of steel) and, during cooling, the steel runs the risk of losing its structure and therefore its mechanical properties. For example, a dual-phase steel heated to 1300° C. is transformed, when it cools, into martensite, which is hard and brittle, and therefore incapable of being drawn.

Furthermore, the sandwich sheets according to the invention have, compared with sandwich sheets consisting of a core comprising a polymer, the following advantages:

excellent weldability, with no discharge of volatile organic compounds;

excellent formability using various techniques, such as for example, bending, drawing or profiling, with no risk of delamination;

excellent resistance to high temperatures, especially temperatures above 200° C., thereby allowing these sandwich sheets to be treated by cataphoresis; and

excellent recyclability.

Apart from temperature resistance and ease of forming, the sandwich sheets according to the invention have the following main advantages:

good mechanical properties in terms of stiffness of the sheets and of the parts produced by forming these sheets;

good mechanical properties of the formed parts, especially fatigue resistance and impact resistance; and

good surface appearance of the sheets obtained, even after forming.

1. A sandwich sheet (2) suitable for a forming and welding operation and exhibiting excellent resistance to high temperatures, comprising:
two sheet metal facings (1, 1′) having a melting point T_{f}; and
a metal core (4) having a melting point T_{c}, it being possible for T_{c} to be equal to or different from T_{f}, characterized in that the core (4) has a density less than the density of each of the facings (1, 1′) and in that the core (4) and each of the facings (1, 1′) are bonded together by means of a metal bonding agent (3, 3′) having a melting point Tₘ of less than T_{c} and less than T_{f}.

2. The sandwich sheet (2) as claimed in claim 1, characterized in that the metal core (4) occupies between 10 and 80% of the volume that separates the two sheet metal facings (1, 1′).

3. The sandwich sheet (2) as claimed in claim 2, characterized in that the metal core (4) occupies between 20 and 60% of the volume that separates the two sheet metal facings (1, 1′).

4. The sandwich sheet (2) as claimed in any one of claims 1 to 3, characterized in that the core (4) consists of a metal wool, a knitted metal fabric, a woven metal fabric, a metal foam or a metal sponge.

5. The sandwich sheet (2) as claimed in any one of claims 1 to 4, characterized in that the core (4) is made of steel.

6. The sandwich sheet (2) as claimed in any one of claims 1 to 5, characterized in that the sheet metal facings (1, 1′) are made of steel.

7. The sandwich sheet (2) as claimed in either of claims 5 and 6, characterized in that the sheet metal facings (1, 1′) and the metal core (4) are made of steel, and the metal bonding agent (3, 3′) is chosen from tin and its alloys, zinc and its alloys, and aluminum and its alloys.

8. A process for manufacturing a sandwich sheet (2), suitable for a forming and welding operation, and exhibiting excellent resistance to high temperatures, comprising two sheet metal facings (1, 1′) having a melting point T_{f}, these being bonded together by a metal core (4) having a melting point T_{c}, it being possible for T_{c} to be equal to or different from T_{f}, the core (4) having a density of less than the density of each of the facings (1, 1′), characterized in that it comprises the steps consisting in:
inserting the metal core (4) between the two sheet metal facings (1, 1′) precoated on at least one of their faces with a metal coating, the melting point T_{coat} of which is below the melting point T_{f} of the sheet metal facing and below the melting point T_{c} of the metal core, such that the coated face of each of the facings (1, 1′) faces the core (4);
heating the assembly formed by the two sheet metal facings (1, 1′) between which the metal core (4) has been inserted at a temperature T lying between the melting point of the metal coating T_{coat} minus 50° C. and the melting point of the metal coating T_{coat} plus 200° C., under speed and duration conditions such that the core (4) adheres to each of the facings (1, 1′); and
cooling the assembly.

9. The process as claimed in claim 8, characterized in that, between the heating and cooling steps, pressure is applied to the assembly formed by the sheet metal facings (1, 1′) and the metal core (4), said pressure being adjusted so as not to damage the structure of the metal core (4).

10. The process as claimed in claim 8 or 9, characterized in that the assembly formed by the sheet metal facings (1, 1′) and the metal core (4) is heated by induction.

11. The process as claimed in any one of claims 8 to 10, characterized in that the thickness of the metal coating of each of the sheet metal facings (1, 1′) is between 5 and 350 μm.

12. The process as claimed in claim 11, characterized in that the thickness of the metal coating of each of the sheet metal facings (1, 1′) is between 20 and 80 μm.

13. The process as claimed in any one of claims 8 to 12, characterized in that the rate at which the assembly formed by the sheet metal facings (1, 1′) and the metal core (4) is heated is greater than or equal to 30° C./s.

14. The process as claimed in any one of claims 8 to 13, characterized in that the time during which the assembly formed by the sheet metal facings (1, 1′) and the metal core (4) is heated is less than 15 s.

15. The process as claimed in any one of claims 8 to 14, characterized in that the melting point of the coating T_{coat} is less than 0.9 times the melting point of the sheet metal facing T_{f} and less than 0.9 times the melting point of the metal core T_{c}.

16. The process as claimed in any one of claims 8 to 15, characterized in that the internal face of each of the sheet metal facings (1, 1′) is coated by hot dipping in a bath of liquid metal chosen from tin and its alloys, zinc and its alloys and aluminum and its alloys.

17. The process as claimed in any one of claims 8 to 16, characterized in that the sheet metal facings (1, 1′) are made of steel.

18. The process as claimed in any one of claims 8 to 17, characterized in that the density of the metal core (4) is less than the density of each of the sheet metal facings (1, 1′).

19. The process as claimed in claim 18, characterized in that the core (4) consists of a metal wool, a knitted metal fabric, a woven metal fabric, a metal foam or a metal sponge.

20. The process as claimed in any one of claims 8 to 19, characterized in that the external face of at least one of the two sheet metal facings (1, 1′) is coated with a coating, the melting point Tₑ of which is above the melting point of the metal coating that coats the internal face of each of the two facings (1, 1′) T_{coat} plus 200° C.

21. A sandwich sheet that can be obtained by the process as claimed in any one of claims 8 to 20.

22. The use of the sandwich sheet (2) as claimed in any one of claims 1 to 7 and 21 for the production of automobile body parts formed, painted and then heat treated.

23. A part obtained as claimed in claim 22, characterized in that it is heat treated at above 160° C.
